(19) United States
(12) Patent Application Publication
(10) Pub. No.: US 2026/0045100 A1
(43) Pub. Date: Feb. 12, 2026

(54) LANE DATA CONSTRUCTION APPARATUS AND METHOD THEREOF

(71) Applicants: Hyundai Motor Company, Seoul (KR); Kia Corporation, Seoul (KR)

(72) Inventors: Yoon BANG, Hwaseong-Si (KR); Deuk Hyeon KIM, Hwaseong-Si (KR)

(73) Assignees: Hyundai Motor Company, Seoul (KR); Kia Corporation, Seoul (KR)

(21) Appl. No.: 18/950,844

(22) Filed: Nov. 18, 2024

(30) Foreign Application Priority Data
Aug. 7, 2024 (KR) 10-2024-0105694

(51) Int. Cl. G06V 20/56; G06T 7/13; G06V 10/25; G06V 10/26; G06V 10/44

(52) U.S. Cl. CPC G06V 20/588; G06T 7/13; G06V 10/25; G06V 10/26; G06V 10/44; G06T 2207/30256

(57) ABSTRACT

A lane data construction apparatus includes a processor that generates a lane image based on semantic segmentation data including semantic information for a lane, generates a plurality of polylines using a plurality of feature points extracted from the lane image, and generates instance segmentation data including instance information related to each lane based on the plurality of polylines and a memory operatively connected to the processor and storing data and an algorithm run by the processor.

### CROSS-REFERENCE TO RELATED APPLICATION

The present application claims priority to Korean Patent Application No 10-2024-0105694, filed on Aug. 7, 2024, the entire contents of which is incorporated herein for all purposes by this reference.

### BACKGROUND OF THE PRESENT DISCLOSURE

### Field of the Present Disclosure

The present disclosure relates to a lane data construction apparatus and a method thereof, and more particularly, relates to technologies for constructing lane data based on instance segmentation.

### Description of Related Art

Driving assistance systems for the convenience of a driver have been loaded into a vehicle. More various types of driving assistance systems have been developed.

Thus, a lane detection technology for assisting with the driving of the vehicle has become advanced. The lane detection technology is a technology for assisting the driver depending on lane detection using a camera loaded into the vehicle, in a situation in which it is difficult to identify a lane using the naked eye. Furthermore, the lane detection technology is used to identify a driving situation even during autonomous driving of the vehicle.

The lane detection technology is to detect a lane based on a camera image and may control a steering system based on the detected lane, thus performing a function, such as lane departure prevention and a lane change.

However, if an error occurs in a camera-based lane detection system or due to direct sunlight or foreign substances, it is difficult to cope with a situation in which it is difficult to perform surrounding recognition using the camera.

Thus, high-performance lane detection software for enhancing lane detection accuracy has been developed.

However, instance segmentation data for a lane is required to implement the high-performance lane detection software, but it takes much cost and time to construct an instance segmentation DB for a lane.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a lane data construction apparatus for extracting feature points from a lane image generated based on semantic segmentation data including semantic information for a lane and generating a polyline connecting the respective feature points to generate instance segmentation data including instance information related to each lane to construct an instance segmentation DB and thus reduce cost and time taken to construct the instance segmentation DB and a method thereof.

Another aspect of the present disclosure provides a lane data construction apparatus for constructing an instance segmentation DB to facilitate development of high-performance lane detection software and a method thereof.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a lane data construction apparatus may include a processor that generates a lane image based on semantic segmentation data including semantic information for a lane, generates a plurality of polylines using a plurality of feature points extracted from the lane image, and generates instance segmentation data including instance information related to each lane based on the plurality of polylines and a memory operatively connected to the processor and storing data and an algorithm run by the processor.

In an exemplary embodiment of the present disclosure, the processor may detect an edge portion of each lane region from the lane image and extract intermediate points in a width direction of the lane as the feature points based on the edge portion and sequentially extracts the feature points every predetermined interval for a longitudinal direction of the lane.

In an exemplary embodiment of the present disclosure, the processor is configured to determine whether a first condition in which a distance between adjacent feature points among the plurality of feature points is less than a predetermined distance reference value and a second condition in which an angle between segments connecting the adjacent feature points is less than a predetermined angle reference value are met and may classify feature points meeting the first condition and the second condition among the plurality of feature points into the same feature point group.

In an exemplary embodiment of the present disclosure, the processor may assign sequence numbers depending on an order of the feature points included in the feature point group and may define a starting point and an end point of the feature point group depending on the sequence numbers of the feature points.

In an exemplary embodiment of the present disclosure, the processor may apply an outline approximation algorithm for each feature point group to generate each of the polylines.

In an exemplary embodiment of the present disclosure, the processor may define each lane depending on a similarity between the polylines and may assign an instance ID for each lane to generate the instance segmentation data including the instance ID.

In an exemplary embodiment of the present disclosure, the processor is configured to determine whether a third condition in which a distance between adjacent polylines among the polylines is less than a predetermined distance reference value and a fourth condition in which an angle between segments connecting starting points and end points of the adjacent polylines among the polylines is less than a predetermined angle reference value are met and may classify polylines meeting the third condition and the fourth condition into the same polyline group.

In an exemplary embodiment of the present disclosure, the processor may recognize the respective polylines included in the polyline group as the same lane.

In an exemplary embodiment of the present disclosure, the processor may set a region of interest (ROI) based on a starting point and an end point of each polyline and may assign an instance ID of a lane to which the ROI belongs to a lane pixel in the ROI.

In an exemplary embodiment of the present disclosure, the processor may set the ROI to a rectangle, may be configured to determine vertex coordinates of the top left for the ROI based on a smaller value between an x-coordinate of the starting point of each polyline and an x-coordinate of the end point of each polyline and a minimum margin value between a y-coordinate of the starting point of each polyline and a y-coordinate of the end point of each polyline, and may be configured to determine vertex coordinates of the bottom right for the ROI based on a larger value between the x-coordinate of the starting point of each polyline and the x-coordinate of the end point of each polyline and a maximum margin value between the y-coordinate of the starting point of each polyline and the y-coordinate of the end point of each polyline.

According to another aspect of the present disclosure, a lane data construction method may include generating a lane image based on semantic segmentation data including semantic information for a lane, generating a plurality of polylines using a plurality of feature points extracted from the lane image, and generating instance segmentation data including instance information related to each lane based on the plurality of polylines.

In an exemplary embodiment of the present disclosure, the lane data construction method according to an exemplary embodiment of the present disclosure may further include detecting an edge portion of each lane region from the lane image and extracting the feature points based on intermediate points in a width direction of the lane based on the edge portion. The extracting of the feature points may include sequentially extracting the feature points every predetermined interval for a longitudinal direction of the lane.

In an exemplary embodiment of the present disclosure, the lane data construction method according to an exemplary embodiment of the present disclosure may further include determining whether a first condition in which a distance between adjacent feature points among the plurality of feature points is less than a predetermined distance reference value and a second condition in which an angle between segments connecting the adjacent feature points is less than a predetermined angle reference value are met and classifying feature points meeting the first condition and the second condition among the plurality of feature points into the same feature point group.

In an exemplary embodiment of the present disclosure, the lane data construction method according to an exemplary embodiment of the present disclosure may further include assigning sequence numbers depending on an order of the feature points included in the feature point group and defining a starting point and an end point of the feature point group depending on the sequence numbers of the feature points.

In an exemplary embodiment of the present disclosure, the generating of the polylines may include applying an outline approximation algorithm for each feature point group to generate each of the polylines.

In an exemplary embodiment of the present disclosure, the generating of the instance segmentation data may include defining each lane depending on a similarity between the polylines and assigning an instance ID for each lane to generate the instance segmentation data including the instance ID.

In an exemplary embodiment of the present disclosure, the defining of each lane may include determining whether a third condition in which a distance between adjacent polylines among the polylines is less than a predetermined distance reference value and a fourth condition in which an angle between segments connecting starting points and end points of the adjacent polylines among the polylines is less than a predetermined angle reference value are met and classifying polylines meeting the third condition and the fourth condition into the same polyline group.

In an exemplary embodiment of the present disclosure, the defining of each lane may include recognizing the respective polylines included in the polyline group as the same lane.

In an exemplary embodiment of the present disclosure, the lane data construction method according to an exemplary embodiment of the present disclosure may further include setting a rectangular region of interest (ROI) based on a starting point and an end point of each polyline and assigning an instance ID of a lane to which the ROI belongs to a lane pixel in the ROI.

In an exemplary embodiment of the present disclosure, the setting of the ROI may include determining vertex coordinates of the top left for the ROI based on a smaller value between an x-coordinate of the starting point of each polyline and an x-coordinate of the end point of each polyline and a minimum margin value between a y-coordinate of the starting point of each polyline and a y-coordinate of the end point of each polyline and determining vertex coordinates of the bottom right for the ROI based on a larger value between the x-coordinate of the starting point of each polyline and the x-coordinate of the end point of each polyline and a maximum margin value between the y-coordinate of the starting point of each polyline and the y-coordinate of the end point of each polyline.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a drawing illustrating a configuration of a lane data construction apparatus according to an exemplary embodiment of the present disclosure;

FIG. 2 is a drawing illustrating a detailed configuration of a processor according to an exemplary embodiment of the present disclosure;

FIG. 3 is a drawing illustrating an instance segmentation image translation process of a lane data construction apparatus according to an exemplary embodiment of the present disclosure;

FIG. 4A, FIG. 4B, FIG. 4C, FIG. 4D, and FIG. 4E are drawings referenced to describe a detailed translation process of an instance segmentation image in a lane data construction apparatus according to an exemplary embodiment of the present disclosure;

FIG. 5 is a drawing illustrating operational flow of a lane data construction method according to an exemplary embodiment of the present disclosure; and

FIG. 6 is a drawing illustrating a computing system according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings. In adding the reference numerals to the components of each drawing, it should be noted that the identical component is designated by the identical numerals even when they are displayed on other drawings. Furthermore, in describing the exemplary embodiment of the present disclosure, a detailed description of well-known features or functions will be ruled out in order not to unnecessarily obscure the gist of the present disclosure.

In describing the components of the exemplary embodiment of the present disclosure, terms such as “first”, “second”, “A”, “B”, “(a)”, “(b)”, and the like may be used. These terms are merely intended to distinguish one component from another component, and the terms do not limit the nature, sequence or order of the corresponding components. Furthermore, unless otherwise defined, all terms including technical and scientific terms used herein include the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

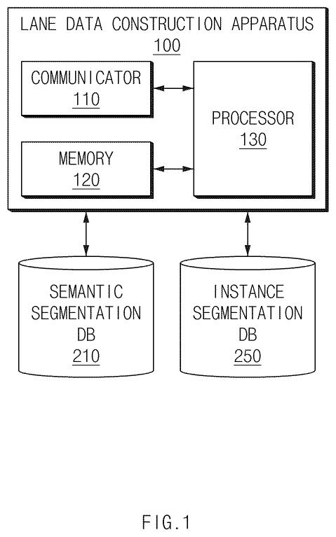

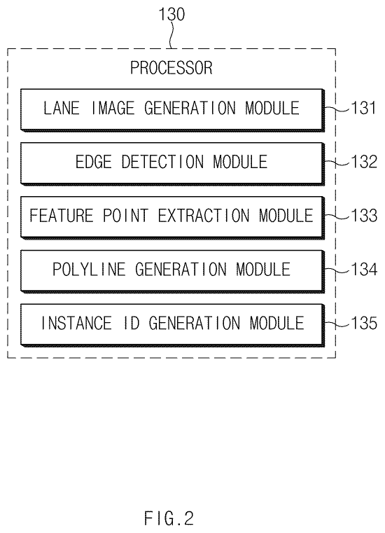

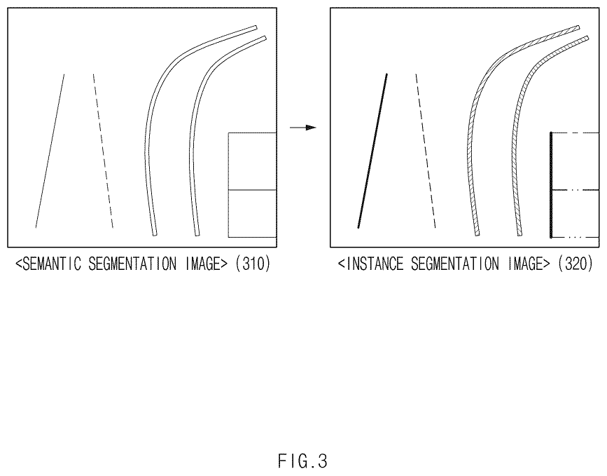

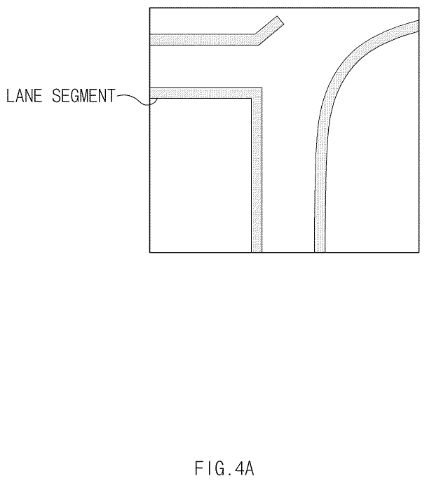

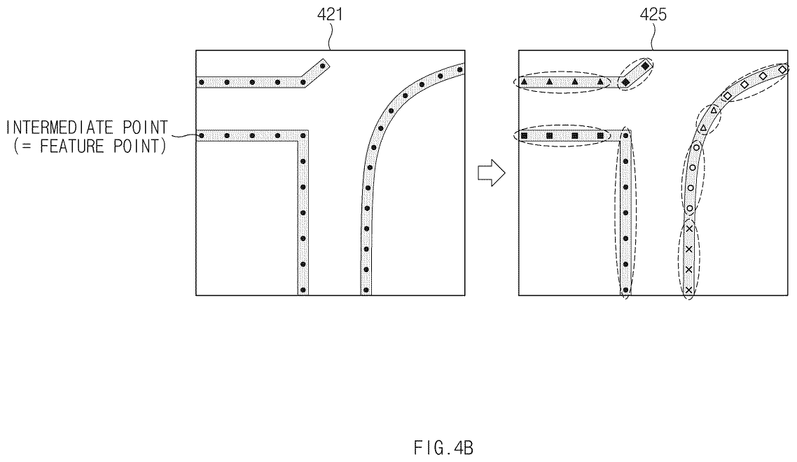

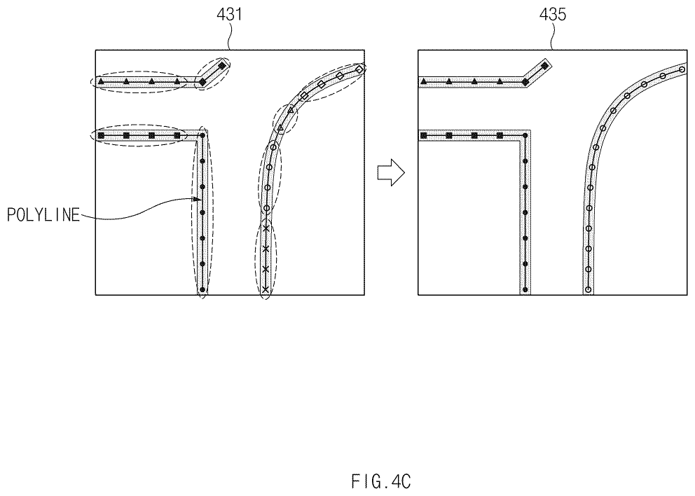

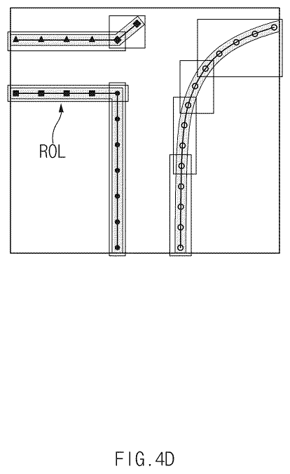

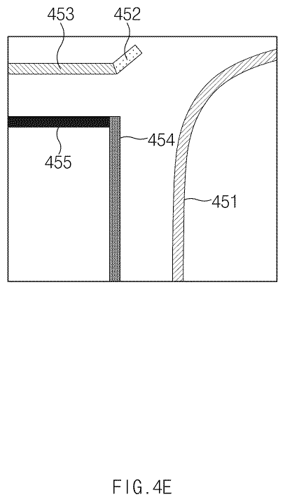

Hereinafter, various exemplary embodiments of the present disclosure will be described in detail with reference to FIG. 1, FIG. 2, FIG. 3, and FIG. 4E. FIG. 1 is a drawing illustrating a configuration of a lane data construction apparatus according to an exemplary embodiment of the present disclosure. FIG. 2 is a drawing illustrating a detailed configuration of a processor according to an exemplary embodiment of the present disclosure. FIG. 3 is a drawing illustrating an instance segmentation image translation process of a lane data construction apparatus according to an exemplary embodiment of the present disclosure. FIGS. 4A to 4E are drawings referenced to describe a detailed translation process of an instance segmentation image in a lane data construction apparatus according to an exemplary embodiment of the present disclosure.

Referring to FIG. 1, a lane data construction apparatus 100 may include a communicator 110, a memory 120, and a processor 130.

The communicator 110 may be a hardware device implemented with various electronic circuits to transmit and receive a signal via a wireless or wired connection, which may transmit and receive information with devices in a vehicle based on a network communication technology in the vehicle.

Herein, the network communication technology in the vehicle may include Controller Area Network (CAN) communication, Local Interconnect Network (LIN) communication, Flex-Ray communication, or the like.

Furthermore, the communicator 110 may further include a communication module for accessing wireless Internet or a communication module for short range communication.

As an exemplary embodiment of the present disclosure, the communicator 110 may receive semantic segmentation data including semantic information for a lane from a semantic segmentation DB 210. Furthermore, the communicator 110 may transmit instance segmentation data of the lane, which is generated based on the semantic segmentation data, to an instance segmentation DB 250.

Herein, semantic segmentation may refer to segmenting an image into several classes or categories. For example, the semantic segmentation may be performed to segment the image into the several classes, such as a road, a vehicle, and a lane. However, the semantic segmentation may be performed not to divide different objects in the same class.

Instance segmentation may refer to identifying a boundary of each object from the image and dividing different objects which belong to the same class. For example, the instance segmentation may be performed to individually separate respective different lanes among the several lanes of the image.

The memory 120 may store data, an algorithm, and/or the like necessary for an operation of the processor 130. As an exemplary embodiment of the present disclosure, the memory 120 may store a lane image generated based on the semantic segmentation data called from the semantic segmentation DB 210, may store feature point information detected by the processor 130 from the lane image, instance identification (ID) information assigned to the lane, and the like, or may store an algorithm for extracting each piece of information from the lane image based on the semantic segmentation data.

Herein, the memory 120 may include at least one type of non-transitory storage medium such as a flash memory type memory, a hard disk type memory, a micro type memory, a card type memory (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic RAM (MRAM), a magnetic disk, or an optical disk.

The processor 130 may be electrically connected to the communicator 110, the memory 120, or the like and may electrically control the respective components. The processor 130 may be an electrical circuit which executes instructions of software and may perform a variety of data processing and determination described below.

The processor 130 may be configured for processing a signal delivered between the respective components of the lane data construction apparatus 100. The processor 130 may be, for example, an electronic control unit (ECU), a micro controller unit (MCU), or another sub-controller, which is loaded into a vehicle.

The processor 130 may access the semantic segmentation DB 210 via the communicator 110 to call the semantic segmentation data for the lane. At the instant time, the processor 130 may detect lane information from the semantic segmentation data called from the semantic segmentation DB 210, may assign an ID to the lane information, and may be configured to generate instance segmentation data based on it. As an exemplary embodiment of the present disclosure, as shown in FIG. 3, the processor 130 may be configured to generate an instance segmentation image 320 based on information detected from a semantic segmentation image 310.

In detail, as shown in FIG. 2, the processor 130 may include a lane image generation module 131, an edge portion detection module 132, a feature point extraction module 133, a polyline generation module 134, and an instance ID generation module 135. Herein, each of the lane image generation module 131, the edge portion detection module 132, the feature point extraction module 133, the polyline generation module 134, and the instance ID generation module 135 may be implemented in a form of an independent module or may be implemented in a form in which a plurality of modules are integrated into one.

In an exemplary embodiment of the present disclosure, each of the lane image generation module 131, the edge portion detection module 132, the feature point extraction module 133, the polyline generation module 134, and the instance ID generation module 135 may be implemented in a form of an independent processor or be implemented in a form in which a plurality of modules are integrated into one processor.

If the semantic segmentation data for the lane is received from the semantic segmentation DB 210, the lane image generation module 131 may separate a lane class region from the semantic segmentation data and may be configured to generate a lane image based on the separated lane class region. Herein, the lane image may be a binary image. An exemplary embodiment of the lane image generated based on the lane class region separated from the semantic segmentation data refers to FIG. 4A.

The edge portion detection module 132 may detect an edge portion of each lane region based on the lane image generated by the lane image generation module 131.

The feature point extraction module 133 may detect a feature point of each lane based on the edge portion of each lane region, which is detected by the edge portion detection module 132. Herein, the feature point extraction module 133 may search for a feature point based on the edge portion of each lane region and may extract an intermediate point for a width direction of the lane as the feature point. An exemplary embodiment of the feature point extracted from each lane region refers to reference numeral 421 of FIG. 4B.

The feature point extraction module 133 may be configured to determine a distance and an angle between feature points for each lane region and may form a group based on feature points, each of which includes a similar position and angle. At the instant time, the feature point extraction module 133 may be configured to determine whether the feature points for each lane region meet a first condition below and a second condition below.

$$distPoint ( {P}_{n - 1} , {P}_{n} ) < {maxDistThreshold}_{1} \qquad < First condition >$$

Herein, Pₙ refers to the nth feature point coordinates (xₙ, yₙ), Pₙ₋₁ refers to the n−1th feature point coordinates (xₙ₋₁, yₙ₋₁), distPoint( ) refers to the distance between the two feature points (Pₙ₋₁, Pₙ), and maxDistThreshold₁ refers to the maximum distance reference value between the two feature points.

In other words, if the distance between the two feature points (Pₙ₋₁, Pₙ) is adjacent to each other to be less than the maximum distance reference value, the feature point extraction module 133 may be configured to determine that the first condition is met.

$$angLine ( \overline{{P}_{n - 2} {P}_{n - 1}} , \overline{{P}_{n - 1} {P}_{n}} ) < {maxAngThreshold}_{1} \qquad < Second condition >$$

Herein, Pₙ refers to the nth feature point coordinates (xₙ, yₙ), Pₙ₋₁ refers to the n−1th feature point coordinates (xₙ₋₁, yₙ₋₁), Pₙ₋₂ refers to the n−2th feature point coordinates (xₙ₋₂, yₙ₋₂), P̅ₙ̅₋̅₁̅P̅ₙ̅ refers to the segment connecting the two feature points (Pₙ₋₁, Pₙ), P̅ₙ̅₋̅₂̅P̅ₙ̅₋̅₁̅ refers to the segment connecting the two feature points (Pₙ₋₂, Pₙ₋₁), angLine( ) refers to the angle formed by the two straight lines P̅ₙ̅₋̅₂̅P̅ₙ̅₋̅₁̅, and P̅ₙ̅₋̅₁̅P̅ₙ̅, and maxAngThreshold₁ refers to the maximum angle reference value between the two straight lines.

In other words, if the angle formed by the two straight lines P̅ₙ̅₋̅₂̅P̅ₙ̅₋̅₁̅, and P̅ₙ̅₋̅₁̅P̅ₙ̅ is similar to each other to be less than the maximum angle reference value, the feature point extraction module 133 may be configured to determine that the second condition is met.

Herein, if the distance and the angle between the feature points for each lane region meet both the first condition and the second condition, the feature point extraction module 133 may form the feature points to be included in the same group. An exemplary embodiment of the feature point group for each lane region refers to reference numeral 425 of FIG. 4B.

At the present time, the feature points which belong to each group may have sequence numbers in an order in which they belong to the group. Thus, the feature point extraction module 133 may define a starting point and an end point depending on the sequence numbers of the feature points which belong to each group.

The polyline generation module 134 may be configured to generate a polyline for each group of the feature points generated by the feature point extraction module 133. Herein, the polyline may refer to a line sequentially connecting respective feature points for each group of the feature points. As an exemplary embodiment of the present disclosure, the polyline generation module 134 may apply a Douglas-Peucker algorithm for each group of feature points to generate a polyline. Herein, the Douglas-Peucker algorithm may be an algorithm for approximating an outline, which may approximate a curve including a plurality of segments connecting vertices to a similar curve with less number of vertices. An exemplary embodiment of the polyline generated for each group of the feature points refers to reference numeral 431 of FIG. 4C.

The polyline generation module 134 may group polylines generated for each group depending on a certain condition. As an exemplary embodiment of the present disclosure, the polyline generation module 134 may be configured to determine a distance and an angle between the polylines for each group and may form a group based on polylines with positions and angles, which are similar to each other as a result of the determination. At the instant time, the polyline generation module 134 may be configured to determine whether the polylines meet a third condition below and a fourth condition below.

$$distPoint ( {Pe}_{m - 1} , {Ps}_{m} ) < {maxDistThreshold}_{2} \qquad < Third condition >$$

Herein, Peₘ₋₁ refers to the end point of the m−1th polyline, Psₘ refers to the starting point of the mth polyline, distPoint( ) refers to the distance between the two points (Peₘ₋₁, Psₘ), and maxDistThreshold₂ refers to the maximum distance reference value between the end points and the starting points of the two polylines.

In other words, if the distance between the end point and the starting point of the two polylines is close to each other to be less than the predetermined maximum distance reference value, the polyline generation module 134 may be configured to determine that the third condition is met. Herein, maxDistThreshold₂ may be set to a value greater than maxDistThreshold₁.

$$angLine ( \overline{{Ps}_{m - 1} {Pe}_{m - 1}} , \overline{{Ps}_{m} {Pe}_{m}} ) < max {AngThreshold}_{2} \qquad 〈 Fourth condition 〉$$

Herein, Peₘ₋₁ refers to the starting point of the m−1th polyline, Peₘ₋₁ refers to the end point of the m−1th polyline, Psₘ refers to the starting point of the mth polyline, Peₘ refers to the end point of the mth polyline, P̅s̅ₘ̅₋̅₁̅P̅e̅ₘ̅₋̅₁̅ refers to the segment connecting the starting point and the end point of the m−1th polyline, P̅s̅ₘ̅P̅e̅ₘ̅ refers to the segment connecting the starting point and the end point of the mth polyline, angLine( ) refers to the angle formed by the two straight lines P̅s̅ₘ̅₋̅₁̅P̅e̅ₘ̅₋̅₁̅ and P̅s̅ₘ̅P̅e̅ₘ̅, and maxAngThreshold₂ refers to the maximum angle reference value between the two straight lines.

In other words, if the angle formed by the two straight lines P̅s̅ₘ̅₋̅₁̅P̅e̅ₘ̅₋̅₁̅ and P̅s̅ₘ̅P̅e̅ₘ̅ is similar to each other to be less than the maximum angle reference value, the polyline generation module 134 may be configured to determine that the fourth condition is met. Herein, maxAngThreshold₂ may be set to a value greater than maxAngThreshold₁.

If the distance and the angle between adjacent polylines among the polylines meet both the third condition and the fourth condition, the polyline generation module 134 may form the polylines to be included in the same group. An exemplary embodiment of the polyline group refers to reference numeral 435 of FIG. 4B.

The instance ID generation module 135 may be configured to determine respective polylines included in the polyline group generated by the polyline generation module 134 as the same lane and may assign an instance ID for each lane.

Furthermore, the instance ID generation module 135 may be configured to generate a rectangular region of interest (ROI) based on the starting points and the end points of the respective polylines generated for each group of the feature points.

The instance ID generation module 135 may obtain vertex coordinates (or first coordinates) of the top left of the rectangular ROI and vertex coordinates (or second coordinates) of the bottom right of the rectangular ROI with reference to Equations 1 and 2 below and may be configured to generate a rectangular region, which includes the first coordinates and the second coordinates as vertices, as the ROI.

$${P}_{m}^{lef \_ top} = \{ min ( {Ps}_{m}^{x} , {Pe}_{m}^{x} ) + margin . min ( {Ps}_{m}^{y} , {Pe}_{m}^{y} ) + margin \} \qquad [ Equation 1 ]$$

In Equation 1 above,

$${P}_{m}^{lef \_ top}$$

refers to the vertex coordinates (x1, y1) of the top left of the rectangular ROI,

$${Ps}_{m}^{x}$$

refers to the x-coordinate value at the polyline starting point,

$${Pe}_{m}^{x}$$

refers to the x-coordinate value at the polyline end point,

$${Ps}_{m}^{y}$$

refers to the y-coordinate value at the polyline starting point,

$${Pe}_{m}^{y}$$

refers to the y-coordinate value at the polyline end point, margin.min refers to the minimum margin value of the two points

$$( {Ps}_{m}^{y} , {Pe}_{m}^{y} ) ,$$

and margin refers to the margin value.

$${P}_{m}^{right\_bottom} = \{ max ( {Ps}_{m}^{x} , {Pe}_{m}^{x} ) + margin . max ( {Ps}_{m}^{y} , {Pe}_{m}^{y} ) + margin \} \qquad [ Equation 2 ]$$

In Equation 2 above,

$${P}_{m}^{right \_ bottom}$$

refers to the vertex coordinates (x2, y2) of the bottom right of the rectangular ROI,

$${Ps}_{m}^{x}$$

refers to the x-coordinate value at the polyline starting point,

$${Pe}_{m}^{x}$$

refers to the x-coordinate value at the polyline end point,

$${Ps}_{m}^{y}$$

refers to the y-coordinate value at the polyline starting point,

$${Pe}_{m}^{y}$$

refers to the y-coordinate value at the polyline end point, margin.max refers to the maximum margin value of the two points

$$( {Ps}_{m}^{y} , {Pe}_{m}^{y} ) ,$$

and margin refers to the margin value. An exemplary embodiment of generating the rectangular ROI based on the starting points and the end points of the respective polylines refers to FIG. 4D.

At the present time, the instance ID generation module 135 may assign an instance ID corresponding to a lane to which the corresponding ROI belongs to a lane pixel which is within the corresponding ROI. An exemplary embodiment of each lane to which the instance ID is assigned refers to FIG. 4E.

Referring to FIG. 4E, reference numerals 451, 452, 453, 454 and 455 refer to lanes 451, 452, 453, 454 and 455. As different instance IDs are assigned to the lanes 451, 452, 453, 454 and 455, the lanes 451, 452, 453, 454 and 455 may be recognized based on the instance IDS, respectively.

Accordingly, the instance ID generation module 135 may be configured to generate a lane image to which an instance ID is assigned for each lane and may store the generated lane image in the memory 120.

The processor 130 may construct the instance segmentation DB 250 based on the lane image to which the instance ID is assigned for each lane and may store a lane image, which is subsequently generated, in the instance segmentation DB 250.

A description will be provided in detail of operational flow of a lane data construction apparatus according to an exemplary embodiment of the present disclosure, which includes the above-mentioned configuration.

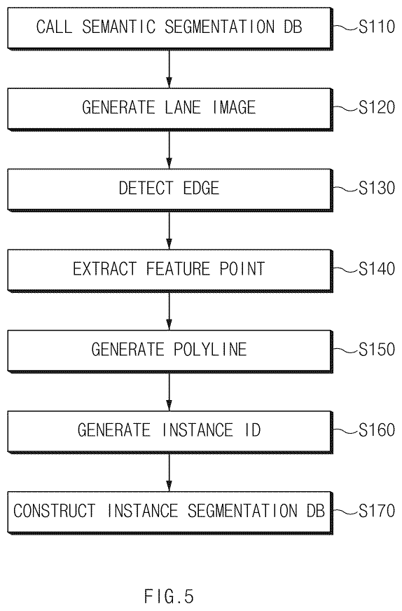

FIG. 5 is a drawing illustrating operational flow of a lane data construction method according to an exemplary embodiment of the present disclosure. Hereinafter, it is assumed that a lane data construction apparatus 100 of FIG. 1 is configured to perform a process of FIG. 5. Furthermore, in a description of FIG. 5, an operation referred to as being performed by a lane data construction apparatus 100 may be understood as being controlled by a processor 130 of the lane data construction apparatus 100.

Referring to FIG. 5, in S110, the lane data construction apparatus 100 may call a semantic segmentation DB 210. In S120, the lane data construction apparatus 100 may be configured to generate a lane image based on semantic segmentation data stored in the semantic segmentation DB 210. In S120, the lane image may be a binary image generated by separating a lane class region from the semantic segmentation data.

In S130, the lane data construction apparatus 100 may detect an edge portion of each lane region from the lane image generated in S120. In S140, the lane data construction apparatus 100 may extract a feature point in the lane region based on the edge portion of each lane region, which is detected in S130. In S140, the lane data construction apparatus 100 may search for a feature point in a width direction of each lane and may extract an intermediate point for the width direction of the lane as the feature point. At the instant time, the lane data construction apparatus 100 may form a group for certain feature points depending on a similar degree of distances and angles between the feature points.

Thereafter, in S150, the lane data construction apparatus 100 may be configured to generate a polyline sequentially connecting the respective feature points for each group of the feature points generated in S140. In S160, the lane data construction apparatus 100 may be configured to generate an instance ID for each group formed according to a distance and an angle between the polylines generated in S150. At the instant time, in S170, the lane data construction apparatus 100 may assign the instance ID generated in S160 to a lane pixel in each group to construct an instance segmentation DB 250 configured for recognizing each lane as a different object.

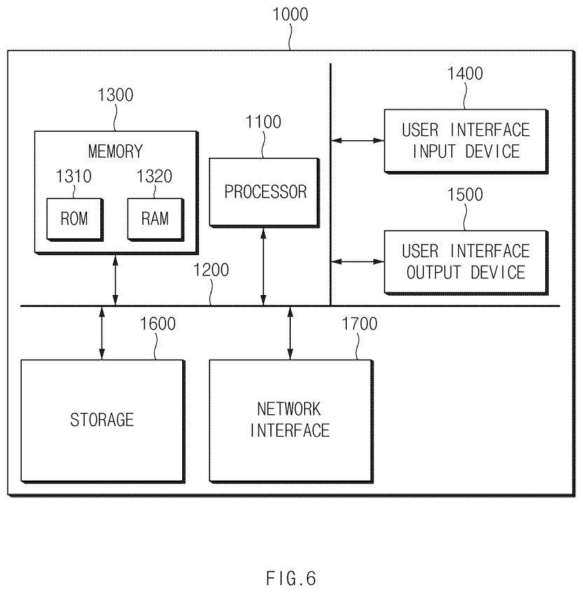

FIG. 6 illustrates a computing system according to an exemplary embodiment of the present disclosure.

Referring to FIG. 6, a computing system 1000 may include at least one processor 1100, a memory 1300, a user interface input device 1400, a user interface output device 1500, storage 1600, and a network interface 1700, which are connected to each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Accordingly, the operations of the method or algorithm described in connection with the exemplary embodiments included in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

As described above, the lane data construction apparatus and the method thereof according to an exemplary embodiment of the present disclosure may extract the feature point from the lane image called from the semantic segmentation DB and may be configured to generate the polyline connecting the respective feature points, and may assign the instance ID for each lane to construct the instance segmentation DB, thus reducing cost and time taken to construct the instance segmentation DB. The lane data construction apparatus and the method thereof according to an exemplary embodiment of the present disclosure may construct the instance segmentation DB to facilitate development of high-performance lane detection software.

According to an exemplary embodiment of the present disclosure, the lane data construction apparatus may extract feature points from a lane image generated based on semantic segmentation data including semantic information for a lane and may be configured to generate a polyline connecting the respective feature points to generate instance segmentation data including instance information related to each lane to construct an instance segmentation DB, thus reducing cost and time taken to construct the instance segmentation DB.

Furthermore, according to an exemplary embodiment of the present disclosure, the lane data construction apparatus may construct the instance segmentation DB, thus facilitating development of high-performance lane detection software.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well-known to a person including ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, a plurality of operations may be merged, or any operation may be divided, and a predetermined operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A lane data construction apparatus, comprising:
a processor configured to generate a lane image based on semantic segmentation data including semantic information for a lane, generate a plurality of polylines using a plurality of feature points extracted from the lane image, and generate instance segmentation data including instance information related to each lane based on the plurality of polylines; and
a memory operatively connected to the processor and storing data and an algorithm run by the processor.

2. The lane data construction apparatus of claim 1, wherein the processor is further configured to:
detect an edge portion of each lane region from the lane image and extract intermediate points in a width direction of the lane as the feature points based on the edge portion; and
sequentially extract the feature points every predetermined interval for a longitudinal direction of the lane.

3. The lane data construction apparatus of claim 1, wherein the processor is further configured to:
determine whether a first condition in which a distance between adjacent feature points among the plurality of feature points is less than a predetermined distance reference value and a second condition in which an angle between segments connecting the adjacent feature points is less than a predetermined angle reference value are met; and
classify feature points meeting the first condition and the second condition among the plurality of feature points into a same feature point group.

4. The lane data construction apparatus of claim 3, wherein the processor is further configured to:
assign sequence numbers depending on an order of the feature points included in the same feature point group and define a starting point and an end point of the same feature point group depending on the sequence numbers of the feature points.

5. The lane data construction apparatus of claim 3, wherein the processor is further configured to:
apply an outline approximation algorithm for each feature point group to generate each of the polylines.

6. The lane data construction apparatus of claim 1, wherein the processor is further configured to:
define each lane depending on a similarity between the polylines and assign an instance identification (ID) for each lane to generate the instance segmentation data including the instance ID.

7. The lane data construction apparatus of claim 6, wherein the processor is further configured to:
determine whether a third condition in which a distance between adjacent polylines among the polylines is less than a predetermined distance reference value and a fourth condition in which an angle between segments connecting starting points and end points of the adjacent polylines among the polylines is less than a predetermined angle reference value are met; and
classify polylines meeting the third condition and the fourth condition into a same polyline group.

8. The lane data construction apparatus of claim 7, wherein the processor is further configured to:
recognize the respective polylines included in the same polyline group as a same lane.

9. The lane data construction apparatus of claim 6, wherein the processor is further configured to:
set a region of interest (ROI) based on a starting point and an end point of each polyline and assign an instance ID of a lane to which the ROI belongs to a lane pixel in the ROI.

10. The lane data construction apparatus of claim 9, wherein the processor is further configured to:
set the ROI to a rectangle;
determine vertex coordinates of a top left for the ROI based on a smaller value between an x-coordinate of the starting point of each polyline and an x-coordinate of the end point of each polyline and a minimum margin value between a y-coordinate of the starting point of each polyline and a y-coordinate of the end point of each polyline; and
determine vertex coordinates of a bottom right for the ROI based on a larger value between the x-coordinate of the starting point of each polyline and the x-coordinate of the end point of each polyline and a maximum margin value between the y-coordinate of the starting point of each polyline and the y-coordinate of the end point of each polyline.

11. A lane data construction method, comprising:
generating, by a processor, a lane image based on semantic segmentation data including semantic information for a lane;
generating, by the processor, a plurality of polylines using a plurality of feature points extracted from the lane image; and
generating, by the processor, instance segmentation data including instance information related to each lane based on the plurality of polylines.

12. The lane data construction method of claim 11, further including:
detecting, by the processor, an edge portion of each lane region from the lane image; and
extracting, by the processor, the feature points based on intermediate points in a width direction of the lane based on the edge portion,
wherein the extracting of the feature points includes:
sequentially extracting the feature points every predetermined interval for a longitudinal direction of the lane.

13. The lane data construction method of claim 12, further including:
determining, by the processor, whether a first condition in which a distance between adjacent feature points among the plurality of feature points is less than a predetermined distance reference value and a second condition in which an angle between segments connecting the adjacent feature points is less than a predetermined angle reference value are met; and
classifying, by the processor, feature points meeting the first condition and the second condition among the plurality of feature points into a same feature point group.

14. The lane data construction method of claim 13, further including:
assigning, by the processor, sequence numbers depending on an order of the feature points included in the same feature point group and defining, by the processor, a starting point and an end point of the same feature point group depending on the sequence numbers of the feature points.

15. The lane data construction method of claim 13, wherein the generating of the polylines includes:
applying an outline approximation algorithm for each feature point group to generate each of the polylines.

16. The lane data construction method of claim 11, wherein the generating of the instance segmentation data includes:
defining each lane depending on a similarity between the polylines; and
assigning an instance identification (ID) for each lane to generate the instance segmentation data including the instance ID.

17. The lane data construction method of claim 16, wherein the defining of each lane includes:
determining whether a third condition in which a distance between adjacent polylines among the polylines is less than a predetermined distance reference value and a fourth condition in which an angle between segments connecting starting points and end points of the adjacent polylines among the polylines is less than a predetermined angle reference value are met and classifying polylines meeting the third condition and the fourth condition into a same polyline group.

18. The lane data construction method of claim 17, wherein the defining of each lane includes:
recognizing the respective polylines included in the same polyline group as a same lane.

19. The lane data construction method of claim 16, further including:
setting, by the processor, a rectangular region of interest (ROI) based on a starting point and an end point of each polyline; and
assigning, by the processor, an instance ID of a lane to which the ROI belongs to a lane pixel in the ROI.

20. The lane data construction method of claim 19, wherein the setting of the ROI includes:
determining vertex coordinates of a top left for the ROI based on a smaller value between an x-coordinate of the starting point of each polyline and an x-coordinate of the end point of each polyline and a minimum margin value between a y-coordinate of the starting point of each polyline and a y-coordinate of the end point of each polyline; and
determining vertex coordinates of a bottom right for the ROI based on a larger value between the x-coordinate of the starting point of each polyline and the x-coordinate of the end point of each polyline and a maximum margin value between the y-coordinate of the starting point of each polyline and the y-coordinate of the end point of each polyline.
